(19) United States
(12) Patent Application Publication
(10) Pub. No.: US 2011/0077139 A1
(43) Pub. Date: Mar. 31, 2011

(54) METHOD FOR PRODUCING FILM BAGS

(76) Inventors: Marcus Kujat, Osnabrueck (DE); Detlef Stoeppelmann, Steinfeld (DE)

(21) Appl. No.: 12/439,551

(22) PCT Filed: Sep. 9, 2006
(86) PCT No.: PCT/EP06/08796

§ 371 Date: Oct. 18, 2010

(51) Int. Cl. B31B 1/00

(52) U.S. Cl. 493/267

(57) ABSTRACT

Foil bags each having V-shaped inset side gussets offset from the upper edge and a resealable closure in an upper opening are made by first stamping notches out of the longitudinal edges of a first foil strip is provided having stamped-out edge notches. Then side gussets are formed on the edges between the notches, and resealable closure strips are mounted on the foil strip sealing the upper edges of the side gussets. A second flat foil strip is set on the side gussets and closure strips of the first foil strip and bonded to the edges of the gussets of the first foil strip to form a gusseted tube. Further welds form the tube into a sectioned strand from which foil bags can be separated.

The invention relates to a method of making foil bags having inset V-section side gussets offset from the upper edge and a resealable closure in an upper opening.

The resealable closure can be designed as a zipper or as a slider. A zipper comprises two interlockable profiled strips detachably connected and without a slide, which in each case have a strip-like carrier and locking ridges engaged in one another. The profiled strip forming the male part of the zipper is in most cases attached to an inner face of the foil bag with weld seams that extend along both edges of the locking ridge. The corresponding profiled strip forming the female part is connected by at least one weld above the other locking ridge to the other wall face of the bag. A slider likewise comprises two profiled strips, which are connected at their lower edge at a weakened tear line. A slide is also provided which grips together and overlaps sealing edges of the profiled strips. The initially flat foil bag can be filled in bag-filling mechanisms. Filling occurs at the top of the bag, the contents being introduced either through opening that is initially available between the resealable closure and a front side of the foil bag, or through the opened resealable closure. Foil bags having the described characteristics are used inter alia for packaging animal feed.

A method of making flat foil bags having the described characteristics is known from DE 10 2005 026 149 [WO 2006/231273]. In the case of the known method stamped pieces that delimit the upper edge of the later formed side gussets are fitted with a flat strip of foil. Next, resealable closure strips are applied to the foil strip transversely to the strip direction and joined at their ends to the foil strip. The foil strip is then guided through a folding station in which the foil strip is folded into a tube and the sides are folded in. In subsequent sealing stations the resealable closures are connected to a front face of the bag to seal together the upper ends of the side gussets and the superposed foil layers are bonded together at welds to form a continuous strand of bag sections from which foil bags can be separated.

A similar method of making resealable foil bags that have inset V-section side gussets offset from the upper edge is described in WO 2006/067617 [US 2008/0085823]. Also, in the method known from this document a strip of foil is folded from a gusseted tube, so that mounting the resealable closure strips must be integrated into the production flow.

With known methods the strip must travel precisely over a forming shoulder, as otherwise there is the danger that the previously placed resealable closure strips catch on the molding tools and the production process is impaired. It is further problematic that the side gussets and the resealable closures are no longer directly accessible after the tubular folding, making subsequent process steps difficult.

The object of the invention is to modify the method of making resealable side gusset bags such that the danger of production interruptions as a result of imprecise strip travel is kept to a minimum.

The subject matter of and solution to this task is a method as claimed in claim 1 having the following steps:

a) at least one first foil strip is provided having stamped-out edge notches;

b) side gussets are formed by C-shaped folding of the edges, the stamped-out notches forming the upper end of the respective side gussets;

c) resealable closure strips are mounted transversely to the longitudinal strip dimension on the foil strip sealing the upper edges of the side gussets;

d) a flat foil extending in the longitudinal strip dimension as second foil strip is set on the side gussets and closure strips of the first foil strip and bonded to the edges of the gussets of the first foil strip to form a gusseted tube;

e) the superposed foil layers are interconnected by further welds to form a strand comprising bag sections and from which foil bags can be separated.

According to the inventive method the flat foil bags are made from two foil strips, the first foil strip being folded C-shaped at the edges to form the side gusset regions that are space apart by the stamped-out notches. The stamped-out notches in each case delimit the upper ends of the side gussets. The stamped-out notches can be cut on the first foil strip before it passes through a folding station and the side gussets are formed. Yet it is also conceivable that the side gussets are formed and then the side gusset regions are stamped out at predetermined intervals. The resealable closure strips are laid on the edge-folded foil strips and are connected over their entire length to the foil strip. The connecting is carried out by one or more welds that seal the upper edges of the side gussets. In terms of the invention however it is also possible that the upper edges of the side gussets are sealed by separate measures, e.g. by applying adhesive labels.

It is possible within the scope of the invention to unroll the second foil strip from a ready-made foil roll. According to a preferred embodiment of the method however the method proceeds as follows: As per the preferred method a foil band is unrolled from a roll and subdivided into at least two foil strips. The first foil strip is folded at its edges corresponding to step b) and resealable closure strips are applied corresponding to step c). The second foil strip is separated from the first foil strip using deflectors, overlain on the first foil strip and in step d) is lain on the first foil strip and connected at the edges of the side gussets to the first foil strip to form a gusseted tube. The stamped-out notches that define the upper edges of the side gussets can be cut in the foil band prior to the foil band being subdivided into foil strips. The inventive method also readily enables double or multiple-line manufacture, in which two or more bag strands are made parallel to one another from a single flat foil band, as per the described method. With double- or multiple-line operation the foil band is subdivided into a plurality of foil strips, first and second foil strips alternating and lying in pairs adjacent one another.

The stamped-out notches that interrupt the side gusset regions of the first foil strip are cut effectively during stepwise advance in a nonmoving web section of the foil strip. The starter foil band provided with the stamped-out notches is then subdivided into the foil strips during continuous movement. Stepwise operation and continuous operation are made possible by using a looper.

The first foil strip is also effectively folded in each case during continuous movement in step b) and is connected in step d) to the tapering second foil strip. Applying and fastening the resealable closure strips (step c)) occurs by contrast during stepwise advance on a nonmoving section of the foil strip. Loopers are provided upstream and downstream in the longitudinal strip direction between the stepwise-operating work station and the work stations through which the foil strip continuously passes.

In further steps following step d) the outer edges of the side gussets can be stiffened by applying longitudinal welds. In addition, the edges of the side gusset bags formed by the second foil strip applied prior to step d) are trimmed to give the bag strand the required dimensional accuracy.

Press closures comprising two superposed and detachably connected profiled strips can be used as resealable closure strips, the profiled strips having a strip-like carrier and locking ridges engaged in one another. Slide closures comprising two interengageable profiled strips and a slide that engages over and slides along the profiled strips can however also be used as resealable closure.

The invention is explained in the following in detail with reference to a drawing showing a single embodiment. Therein:

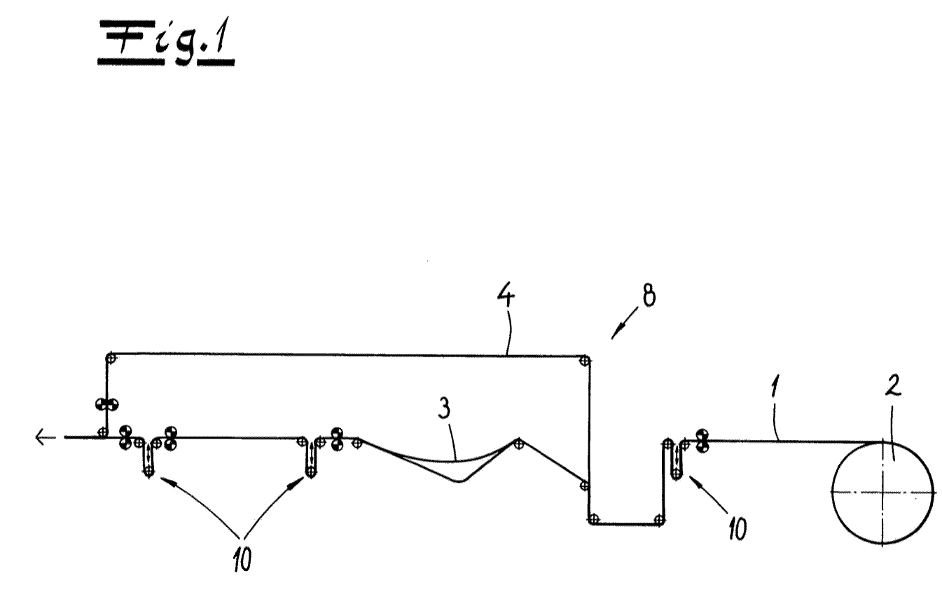

FIG. 1 a diagram of how to make foil bags having inset V-section side gussets offset from the upper edge and a resealable closure in an upper opening,

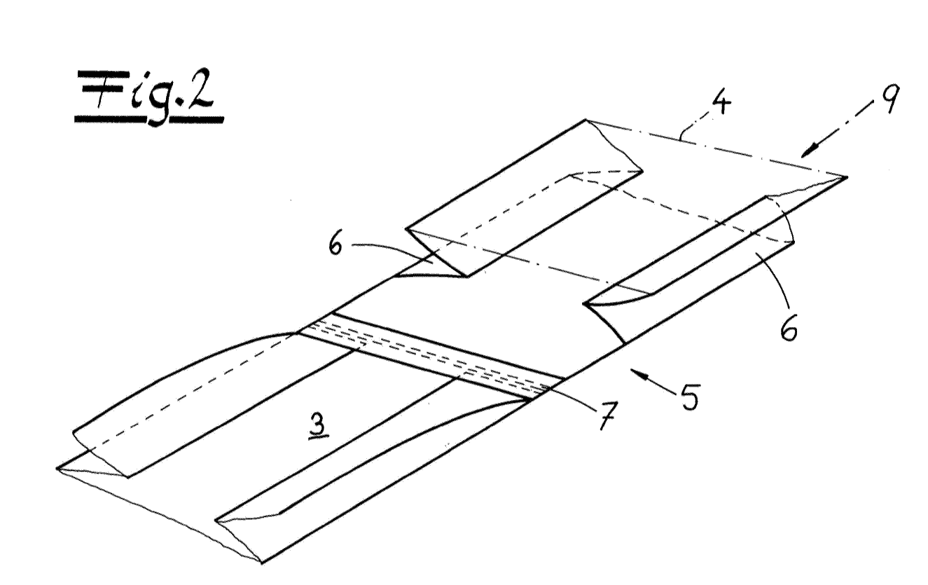

FIG. 2 shows the setting of resealable closure strips in the method illustrated in FIG. 1, and

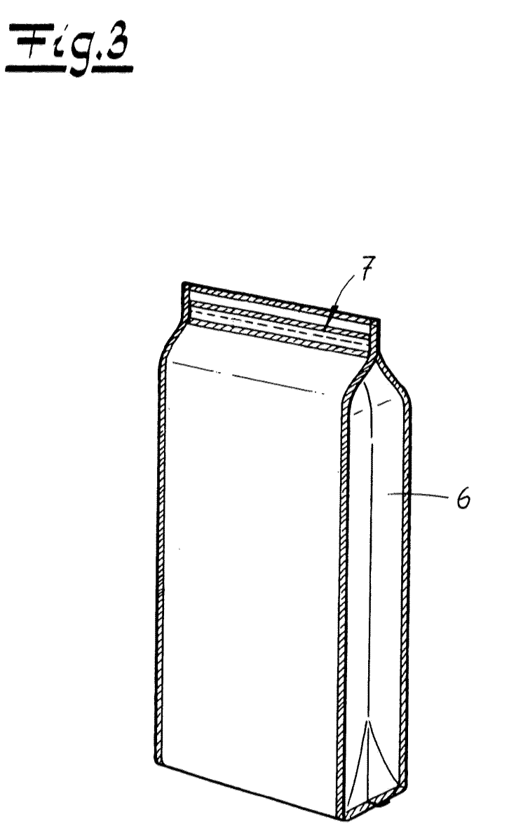

FIG. 3 shows a product resulting from the described method.

In the method illustrated in FIG. 1 a foil band 1 is pulled off a roll 2 and subdivided into at least two strips 3 and 4. The first foil strip 3 has stamped-out edge notches 5 that had been cut earlier in the foil band 1. Side gussets 6 are formed by C-shaped folds at its edges so that the stamped-out notches 5 in each case delimit the upper ends of the respective side gussets (FIG. 2). Resealable closure strips 7 are mounted on the foil strip 3 extending transversely of the longitudinal strip dimension between the edges over the entire width of the folded foil strip 3 at and closing the upper ends of the side gussets 6. The second foil strip 4 separated from the foil band is guided off by deflectors 8 from the first foil strip 3, transversely shifted, and overlain with the first foil strip 3. After this, the second foil strip 4 is bonded to the first foil strip 3, the foil strip 4 advancing parallel to the longitudinal strip dimension and being connected at its edges to the side gussets 6 of the first foil strip 3 to form a gusseted tube 9. The outer edges of the side gussets 6 are stiffened by the longitudinal welds. Also, the edges of the gusseted tube 9, at least the edges formed by the applied second foil strip 4, are trimmed. In further steps not shown in FIG. 1 the superposed foil layers are connected at further welds into a sequence of bag sections from which foil bags can be separated.

The method illustrated in FIG. 1 is composed of steps that are cyclically repeated continuously. The stamped-out notches 5 that form the upper edges of the side gussets 6 are thus cut in the nonmoving foil band 1 between steps when it is pulled off the roll 2. The foil band provided with the stamped-out notches is then cut continuously into the foil strips 3 and 4. A looper 10 that the foil strip enters stepwise and from which it exits continuously at a predetermined constant travel speed is provided to match stepwise movement to continuous movement. The first foil strip 3 is in any case folded continuously and later connected to the second foil strip 4 also continuously. The resealable closure strips 7 are applied cyclically at a nonmoving section of the foil strip 3. Further loopers 10 are likewise provided flanking the stepwise-operating work station for applying and fastening the resealable closure strips 7 and the work stations upstream and downstream in the web travel direction therefrom, through which the foil strip 3 moves continuously.

The method illustrated in FIG. 1 allows simultaneous manufacture or two or more product lines, with two or more bag strands produced parallel to one another at the same time from the flat foil band 1 according to the described method. In the case of dual- or multiple manufacture the foil band is subdivided into a plurality of foil strips, first and second foil strips 3 and 4 assigned to one another in each case lying adjacent one another.

The product illustrated in FIG. 3 has the resealable closure strip 7 in the form of a zipper in the top region. This comprises two superposed and detachably connectable profiled strips, which in each case have a strip-like carrier and locking ridges engaged in one another. The inventive method however readily also allows both the processing of slide closures, which comprise two superposed and detachably connected profiled strips and a slide, which overlaps sealing edges of the profiled strips in the manner of a tab, and of Velcro® and similar closure systems.

1. A method of making foil bags having V-shaped inset side gussets offset from the upper edge and a resealable closure in an upper opening, comprising the following steps:
a) at least one first foil strip is provided having stamped-out edge notches;
b) side gussets are formed by C-shaped folding of the edges, the stamped-out notches forming the upper end of the respective side gussets;
c) resealable closure strips are mounted transversely to the longitudinal strip dimension on the foil strip sealing the upper edges of the side gussets;
d) a flat foil extending in the longitudinal strip dimension as second foil strip is set on the side gussets and closure strips of the first foil strip and bonded to the edges of the gussets of the first foil strip to form a gusseted tube;
e) the superposed foil layers are interconnected by further welds to form a strand comprising bag sections and from which foil bags can be separated.

2. The method as claimed in claim 1 wherein the upper edges of the side gussets are sealed with the resealable closure strips applied in step c).

3. The method as claimed in claim 1 wherein a foil band is unrolled from a roll and subdivided into at least two foil strips, in that the first foil strip is folded at its edges corresponding to step b) and corresponding to step c) the resealable closure strips are placed on the first foil strip and in that the second foil strip is separated from the first foil strip using deflectors, in step d) is overlain on the first foil strip, fed to the first foil strip, and connected to the edges of the side gussets of the first foil strip to form the gusseted tube.

4. The method as claimed in claim 3 wherein the stamped-out notches are cut in the foil band before the foil band is subdivided into the foil strips.

5. The method as claimed in claim 3 wherein the foil band is subdivided into a plurality of foil strips, alternate first and second foil strip in each case lying adjacent to one another.

6. The method as claimed in claim 3 wherein the stamped-out notches are cut during stepwise advance in a nonmoving web section of the foil band and that the foil strip provided with the stamped-out notches is subdivided continuously into the foil strips, the step-wise and the continuous advance being compensated for by a looper.

7. The method as claimed in claim 1 wherein the first foil strip is folded continuously in step b) and in step d) is connected to the incoming second foil strip, and in that in step c) the resealable closure strips are attached at a nonmoving section during stepwise advance of the foil strip, loopers being provided upstream and downstream in the longitudinal strip travel direction between the stepwise-operating work station and the work stations through which the foil strip continuously passes.

8. The method as claimed in claim 1 wherein the outer edges of the side gussets are stiffened by longitudinal welds.

9. The method as claimed in claim 1 wherein the edges of the gusseted tube that are formed by the second foil strip applied in step d) are trimmed.

10. The method as claimed in claim 1 wherein press closures that two superposed and detachably connected profiled strips are used as resealable closure strips, the profiled strips in each case having a strip-like carrier and locking ridges engaged in one another.

11. The method as claimed in claim 1 wherein slide closures that comprise two interengageable profiled strips detachably connectable to one another and a slide that fits over them for sealing edges of the profiled strips are used as resealable closure strips.
